(19) United States
(12) Patent Application Publication
(10) Pub. No.: US 2018/0312952 A1
(43) Pub. Date: Nov. 1, 2018

(54) SHEETS MADE FROM ALUMINUM-MAGNESIUM-ZIRCONIUM ALLOYS FOR AEROSPACE APPLICATIONS

(71) Applicant: CONSTELLIUM ISSOIRE, Issoire (FR)

(72) Inventors: Gaëlle POUGET, Grenoble (FR); Jean-Christophe EHRSTROM, Grenoble (FR); Christophe SIGLI, Grenoble (FR)

(21) Appl. No.: 15/768,362

(22) PCT Filed: Oct. 11, 2016
(86) PCT No.: PCT/FR2016/052621

§ 371 Date: Apr. 13, 2018

(30) Foreign Application Priority Data
Oct. 15, 2015 (FR) 1559786

(51) Int. Cl. C22F 1/047; C22C 21/08; B64C 1/00

(52) U.S. Cl. CPC C22F 1/047; B64C 1/12; B64C 1/00; C22C 21/08

(57) ABSTRACT

The invention relates to wrought aluminum and magnesium alloy products (type Al—Mg, also known under the name of aluminum alloy of the 5XXX series according to the Aluminum Association), more particularly Al—Mg—Zr alloy products having a high mechanical strength and good aptitude for forming. The invention also has for object a method for manufacturing as well as the use of these products intended for transports and in particular in aeronautics and space construction.

### FIELD OF THE INVENTION

The invention relates to wrought aluminum and magnesium alloy products (type Al—Mg, also known under the name of aluminum alloy of the 5XXX series according to the Aluminum Association), more particularly Al—Mg—Zr alloy products having a high mechanical strength and good aptitude for forming. The invention also has for object a method for manufacturing as well as the use of these products intended for transports and in particular in aeronautics and space construction.

### STATE OF THE ART

Wrought aluminum alloy products are developed in particular for producing structural elements intended for the transport industry, in particular for the aeronautical industry and the space industry. For these industries, the performance of the products must constantly be improved and new alloys are developed in order to have in particular high mechanical strength, low density, excellent resistance to corrosion and very good aptitude for forming. Such a complex forming can be carried out hot, for example by creep forming.

Al—Mg alloys have been studied intensively in the transport industry, in particular in road and sea transport, due to their excellent properties for use such as weldability, resistance to corrosion and formability, in particular in little worked tempers such as the O temper and the H111 temper. The designation of these alloys follows the rules of The Aluminum Association, and that for tempers is defined in European standard EN 515.

These alloys have however a relatively weak mechanical strength for the aeronautical industry and the space industry.

There is therefore a need for wrought Al—Mg alloy products that have a low density as well as improved properties in relation to those of known products, in particular in terms of mechanical strength, resistance to corrosion and aptitude for forming. Such products must in addition be able to be obtained according to a method of manufacture that is reliable, economical and easily adaptable to a conventional manufacturing line.

### OBJECT OF THE INVENTION

A first objective of the invention is a wrought aluminum alloy product having composition, in % by weight, Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; the remainder being aluminum.

The invention has also for object a method for manufacturing said wrought aluminum alloy product comprising the successive steps of:
a) casting an unwrought product in aluminum alloy having composition, in % by weight, Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; the remainder being aluminum;
b) optionally, homogenizing;
c) hot working of the unwrought product at an end of working temperature greater than 250° C., preferably between 250 and 350° C.;
d) heat or thermomechanical treatment at a temperature between 250 and 350° C., preferably between 275 and 325° C.

The invention further has for object the use of said wrought product for producing aluminum alloy structural elements of aircraft according to the invention, having been subjected to a heat treatment or a thermomechanical treatment at a temperature between 250 and 350° C. and having, at mid-thickness, for a thickness of 0.5 to 30 mm, a substantially non-recrystallized microstructure.

### DESCRIPTION OF THE FIGURES

FIG. 1: Micrograph representative of a microstructure referred to as “non-recrystallized” (sample of the alloy C observed after a heat treatment for 1 h at 300° C. and an etching of the anodic oxidation type, plane LxTC at mid-thickness).

FIG. 2: Micrograph representative of a microstructure referred to as “partially recrystallized” (sample of the alloy B observed after a heat treatment for 1 h at 300° C. and an etching of the anodic oxidation type, plane LxTC at mid-thickness).

FIG. 3: Micrograph representative of a microstructure referred to as “recrystallized” (sample of the alloy A observed after a heat treatment for 1 h at 300° C. and an etching of the anodic oxidation type, plane LxTC at mid-thickness).

FIG. 4: Correlation between Vickers hardness HV₂₀ and yield strength R_{p0.2}

### DESCRIPTION OF THE INVENTION

Unless mentioned otherwise, all of the indications concerning the chemical composition of alloys are expressed as a percentage by weight based on the total weight of the alloy. By way of example, the expression 1.4 Cu means that the content in copper expressed in % by weight is multiplied by 1.4. The designation of alloys is done in accordance with the rules of “The Aluminum Association”, known to those skilled in the art.

The density depends on the composition and is determined by calculation rather than by a weight measurement method. The values are calculated in accordance with the procedure of “The Aluminum Association”, which is described on pages 2-12 and 2-13 of “Aluminum Standards and Data”. The definitions of the tempers are indicated in European standard EN 515.

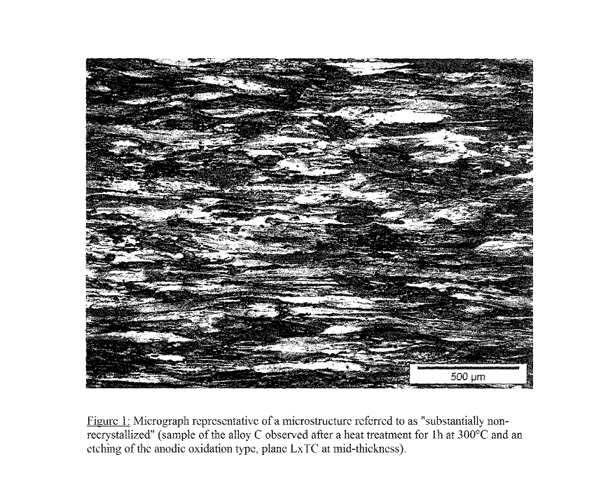

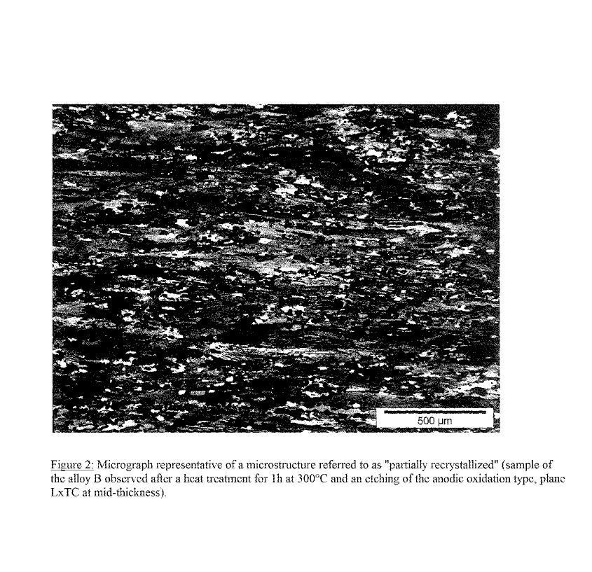

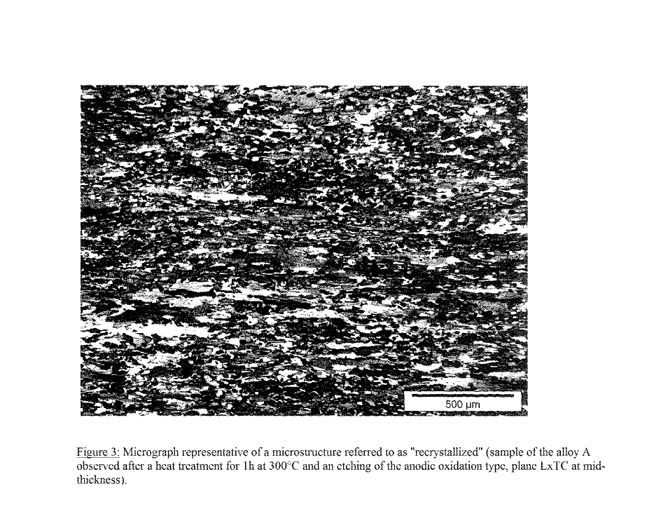

The microstructure (structure of the grains in the plane LxTC at mid-thickness, t/2) of the samples is evaluated quantitatively for this invention after a metallographic etching of the anodic oxidation type and under polarized light:
the term “substantially non-recrystallized” is used when the granular structure has little or no recrystallized grains, typically less than 20%, preferably less than 15% and more preferably less than 10% of the grains are recrystallized (FIG. 1 is a micrograph representative of this microstructure referred to as “substantially non-recrystallized”);
the term “recrystallized” is used when the granular structure has a substantial proportion of recrystallized grains, typically more than 50%, preferably more than 60% and more preferably more than 80% of the grains are recrystallized (FIG. 3 is a photograph representative of this microstructure referred to as “recrystallized”);
the term “partially recrystallized” is used when the granular structure is intermediary between the two preceding ones (FIG. 2 is a photograph representative of this microstructure referred to as “partially recrystallized”).

The Vickers hardness is determined according to standard NF EN ISO 6507-1 (March 2006) in the plane LxLT of the samples and after machining of 1/10 of the thickness of the sheet (load of 20 kg). It is known that the change in the properties, and in the hardness in particular, is a means for evaluating the level of recovery/recrystallization of an aluminum alloy (R. Develay. Traitements thermiques des alliages d'aluminium. Techniques de l'lngdnieur, 1986, vol. M1290, p. 11/G. E. Tooten, D. S. MacKenzie. Handbook of Aluminum—Volume 2: Alloy production and materials manufacturing, 2005, p. 202).

The parameter λ, representing the loss of hardness associated with a heat treatment, is defined as follows:

$$λ = \frac{{HV}_{such as worked} - HV}{{HV}_{such as worked} - {HV}_{reX}}$$

with HV_{such as worked}: initial hardness after hot working;

HV_{reX}: hardness corresponding to the recrystallized state (here after 1 h at 400° C.);

HV: hardness of the sample.

It is typically admitted that beyond a loss of hardness of 40% (λ>0.4), an aluminum alloy starts to recrystallize (R. Develay. Traitements thermiques des alliages d'aluminium. Techniques de l'lngdnieur, 1986, vol. M1290, p. 11/G. E. Tooten, D. S. MacKenzie. Handbook of Aluminum—Volume 2: Alloy production and materials manufacturing, 2005, p. 202).

Unless mentioned otherwise, the definitions of standard EN 12258 apply.

In the framework of this invention, the term “structural element” of a mechanical construction refers to a mechanical part for which the static and/or dynamic mechanical properties are particularly important for the performance of the structure and for which a structural calculation is usually prescribed or carried out. These are typically elements of which the failure is able to endanger the safety of said construction, of its users, or of others. For an aircraft, these structural elements include in particular the elements that comprise the fuselage (such as fuselage skin, stringers), bulkheads, circumferential frames, wings (such as the upper or lower wing skin, stringers or stiffeners, ribs, spars, floor beams and seat tracks) and the tailplane comprised in particular of horizontal or vertical stabilizers, as well as the doors.

The wrought aluminum alloy product according to the invention has the following particular composition, in % by weight: Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; other elements ≤0.05 each and ≤0.15 in association; the remainder being aluminum. Such a product is in particular able to be subjected to a heat treatment for desensitization to corrosion and/or able to be hot formed by thermomechanical treatment, in particular creep forming, at a temperature between 250 and 350° C., preferably between 275 and 325° C., while still retaining, at mid-thickness, for a thickness of 0.5 to 20 mm, preferably from 0.5 to 15 mm and, even more preferably from 0.5 to 10 mm, a substantially non-recrystallized microstructure.

According to an advantageous embodiment, the aluminum alloy of said wrought product comprises from 4.4 to 5.3% by weight of Mg, preferably from 4.8 to 5.2% by weight of Mg. Excellent results have been obtained for alloys according to this embodiment in particular regarding the static mechanical properties.

The aluminum alloy comprises from 0.4 to 0.7% by weight of Li, preferably from 0.4 to 0.6% by weight of Li. The inventors have observed that such a content in lithium makes it possible, in the presence of certain alloying elements forming crystallographic structural phases L1₂ of which in particular zirconium, to retain a substantially non-recrystallized microstructure during a heat or thermomechanical treatment such as described hereinabove. Such a content in Li makes it possible to very significantly improve the static mechanical properties, in particular the yield strength (R_{p0.2}) of the wrought products according to the invention. In a preferred embodiment, the density of said wrought products according to the invention is less than 2.64, more preferably less than 2.62.

The wrought aluminum alloy product according to the invention comprises from 0.5 to 0.9% by weight of Mn, preferably from 0.6 to 0.9% by weight of Mn. A controlled content in manganese participates in improving static mechanical characteristics.

The aluminum alloy product according to the invention comprises from 0.08 to 0.15% by weight of Zr, preferably from 0.11 to 0.15%. The inventors think that such a content in Zr, associated in particular with the particular content of Li, allows for the formation of dispersoids Al₃(Zr,Li) of crystallographic structure L1₂, conferring upon the product according to the invention a high resistance to recrystallization, in particular during a heat or thermomechanical treatment at a temperature between 250 and 350° C., preferably between 275 and 325° C. The substantial absence or the low quantity of lithium in solid solution in the alloy coming from the method of manufacture according to the invention therefore appears to be an essential characteristic to the resistance to recrystallization described hereinabove.

The alloy product according to the invention can also include a content in scandium less than or equal to 0.4% by weight, preferably from 0.15 to 0.3% by weight. The inventors think that the presence of scandium in such a limited content, combined with the presence of Zr and of Li, is able to amplify the resistance to the recrystallization described hereinabove.

The wrought aluminum alloy product can furthermore include Fe in a content, in % by weight, less than or equal to 0.25%, preferably less than or equal to 0.1%, more preferably less than or equal to 0.07%. The inventors think that a minimum content in Fe, as well as possibly that of Si, can participate in improving the mechanical properties and in particular the fatigue properties of the alloy. Likewise, the aluminum alloy can comprise up to 0.2% by weight of Si, preferably the content in Si is less than or equal to 0.1% by weight, preferably 0.05%. Excellent results have in particular been obtained for a content in Fe from 0.02 to 0.07% by weight and/or a content in Si from 0.02 to 0.05% by weight.

The wrought aluminum alloy product can also include Zn in a content, in % by weight, less than or equal to 0.4%, preferably from 0.2 to 0.4%. The presence of Zn in a limited content has given excellent results in terms of combining the properties of density and of resistance to corrosion in particular.

According to an embodiment, the wrought aluminum alloy product comprises Ti in a content, in % by weight, less than or equal to 0.15, preferably less than or equal to 0.05, more preferably from 0.005 to 0.04%, and even more preferably from 0.01 to 0.03% of Ti. The presence of Ti in such a specific content allows for controlling the grain size during the casting of the alloy.

The wrought aluminum alloy product can also include at least one element chosen from: erbium, ytterbium, gadolinium, yttrium, hafnium and niobium, with the total content of this or of these elements, in % by weight, being less than or equal to 0.2, preferably from 0.05 to 0.2. The presence of at least one of these elements makes it possible to reinforce the effect of the Li in the presence of Zr for the formation of dispersoids Al₃(Zr,Li) of crystallographic structure L1₂.

The aluminum alloy product according to the invention can further comprise up to 0.05% by weight each and up to 0.15% by weight in association with other elements, added voluntarily or not.

Certain elements can be detrimental for the Al—Mg—Li—Zr alloys such as described hereinabove, in particular for transformation reasons of the alloy such as the toxicity and/or breakage during the working. It is therefore preferable to limit these elements to a very low level, i.e. less than or equal to 0.05% by weight or even less. In an advantageous embodiment, the products according to the invention have a maximum content of 10 ppm of Na, preferably 8 ppm of Na, and/or a maximum content of 20 ppm of Ca.

The wrought aluminum alloy product according to the invention is in particular able to be subjected to a heat or thermomechanical treatment at a temperature between 250 and 350° C., preferably between 275 and 325° C., preferably for a period from 30 min to 4 h, more preferably from 1 h to 3 h, while still retaining, at mid-thickness, for a thickness of 0.5 and 20 mm, a substantially non-recrystallized microstructure.

Said wrought product further has a hardness HV such that λ<0.4, preferably <0.3 and, more preferably <0.25.

The method of manufacturing products according to the invention comprises the successive steps of elaborating a bath of liquid metal in such a way as to obtain an Al—Mg—Li—Zr alloy according to the particular composition of this invention; the casting of said alloy in an unwrought product; optionally the homogenizing of the unwrought product; the hot working of the unwrought product at an end of working temperature greater than 250° C., preferably between 250 and 350° C.; the heat or thermomechanical treatment of the unwrought product hot worked at a temperature between 250 and 350° C., preferably between 275 and 325° C.

The method of manufacture therefore consists firstly in casting an unwrought product in Al—Mg—Li—Zr alloy having composition, in % by weight: Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; other elements ≤0.05 each and ≤0.15 in association; the remainder being aluminum. A bath of liquid metal is therefore carried out then cast in an unwrought product, typically a rolling ingot, an extrusion billet or a forging stock. Preferably, the bath of liquid metal is cast in the form of a rolling ingot.

Following the step of casting of the unwrought product, the method for manufacturing optionally comprises a step of homogenizing the unwrought product. Preferably, the product is heated between 450 and 550° C. before the hot working.

The unwrought product is then hot worked, typically by extrusion, rolling and/or forging, in order to obtain a worked product. The hot working is carried out at an end of working temperature greater than 250° C., preferably between 250 and 350° C. Typically, such end of working temperatures correspond to input temperatures in a hot rolling mill of approximately 500° C. According to an advantageous embodiment, the hot working is a working by rolling of the unwrought product.

The hot worked product is subjected to a heat or thermomechanical treatment at a temperature between 250 and 350° C., preferably between 275 and 325° C. and this preferably during a period from 30 min á 4 h, more preferably from 1 h at 3 h. This treatment can be a heat treatment allowing for a desensitization of the product to corrosion or a thermomechanical treatment allowing for the hot forming of said product, typically the hot forming thereof by creep forming, and possibly the desensitization to the corrosion of the product.

According to a preferred embodiment, the method according to the invention is free of any step of cold working inducing a total plastic cold-working greater than or equal to 2%, preferable greater than or equal to 1%. The inventors revealed a detrimental effect of such a step of cold working on the resistance to recrystallization described hereinabove for the product object of this invention.

The wrought products according to the invention are preferably extruded products such as profiles, rolled products such as sheets or plates and/or forged products. Preferably, the wrought products according to the invention are sheets.

Advantageously, and in particular for fuselage sheets, the wrought products according to the invention have a thickness from 0.5 to 30 mm, preferably from 0.5 to 20 mm, more preferably from 0.5 to 15 mm and, even more preferably from 2 to 8 mm.

The method described hereinabove makes it possible to obtain wrought products having, at mid-thickness, for a thickness such as described hereinabove, a substantially non-recrystallized microstructure. Said wrought products further have a hardness HV such that λ<0.4, preferably <0.3 and, more preferably <0.25.

The wrought products according to the invention are advantageously used for carrying out a structural element of an aircraft, preferably a fuselage skin.

The products and methods according to the invention make it possible in particular the obtaining of aluminum alloy structural elements of aircraft having composition, in % by weight, Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; the remainder being aluminum; having been subjected to a heat treatment or a thermomechanical treatment at a temperature between 250 and 350° C. and having, at mid-thickness, for a thickness of 0.5 and 30 mm, a substantially non-recrystallized microstructure.

### Example

Several unwrought Al—Mg—Zr alloy products of which the composition is given in table 1 were cast. The alloy C has a composition according to the invention. The density of the alloys was calculated in accordance with the procedure of The Aluminum Association described on pages 2-12 and 2-13 of “Aluminum Standards and Data”.

TABLE 1
Composition in % by weight and density of the Al—Mg—Zr alloys used

| Alloy | Si | Fe | Cu | Mn | Mg | Zn | Ti | Zr | Li | Density |
|---|---|---|---|---|---|---|---|---|---|---|
| A | 0.04 | 0.06 | <0.01 | 0.78 | 5.40 | 0.32 | 0.02 | 0.14 | <0.1 | 2.65 |
| B | 0.04 | 0.06 | <0.01 | 0.78 | 4.98 | 0.30 | 0.02 | 0.13 | 0.25 | 2.63 |
| C | 0.03 | 0.07 | <0.01 | 0.73 | 4.97 | 0.30 | 0.02 | 0.12 | 0.57 | 2.61 |

Book mold ingots (180×30×262 mm) were cast under inert atmosphere. They have been subjected to a step of heat treatment for 12 h at 510-530° C. Samples 12 mm thick sampled in these book mold ingots were hot worked in plane compression at 270-290° C. and up to a thickness of 3 mm using a machine of the “Servotest®” type. Half of the samples were finally subjected to a heat treatment for approximately 1 h at 300±3° C. or approximately 1 h at 400±3° C., with this heat treatment being representative of a step of hot forming such as a step of “creep-forming” used for forming double curvature panels of the fuselage panels used in the field of aeronautics.

The Vickers hardness was also measured for the alloys and conditions described hereinabove (plane LxLT, after machining of 1/10 of the thickness of the sample, load of 20 kg). The hardness measurements obtained, carried out according to standard NF EN ISO 6507-1 (March 2006), are shown in table 2.

The parameter λ, representing the loss of hardness associated with a heat treatment, is defined as follows:

$$λ = \frac{{HV}_{such as worked} - HV}{{HV}_{such as worked} - {HV}_{reX}}$$

with HV_{such as worked}: initial hardness after hot working;

HV_{reX}: hardness corresponding to the recrystallized state (here after 1 h at 400° C.);

HV: hardness of the sample.

The values of the parameter λ are shown in table 2.

TABLE 2
Vickers Hardness (plane LxLT, t/10) of the samples, evaluated according
to the standard NF EN ISO 6507-1 (March 2006), and parameter λ,
representing the loss of hardness associated with a heat treatment,

| Alloy | | Hardness (HV₂₀) | λ |
|---|---|---|---|
| A | such as worked | 97 | 0 |
| | +1 h 300° C. | 89 | 0.55 |
| | +1 h 400° C. | 82 | 1 |
| B | such as worked | 101 | 0 |
| | +1 h 300° C. | 92 | 0.52 |
| | +1 h 400° C. | 84 | 1 |
| C | such as worked | 101 | 0 |
| | +1 h 300° C. | 98 | 0.21 |
| | +1 h 400° C. | 86 | 1 |

After a heat treatment for one hour at approximately 300° C., the alloy C has a Vickers hardness substantially identical to that directly measured after hot working (−3 HV₂₀) while the alloys A and B have a decrease in hardness of respectively 8 and 9 HV₂₀. The loss of hardness (parameter λ) associated with a heat treatment for one hour at approximately 300° C. is therefore 55 and 52% for the alloys A and B respectively, and 21% for the alloy C. Contrary to alloys A and B, the alloy C does not therefore have any recrystallization after a heat treatment of one hour at approximately 300° C. because λ<0.4 (the loss of hardness observed is only associated with the recovery).

The microstructure (structure of the grains) of the samples was observed after metallographic etching of the anodic oxidation type and under polarized light. Three states were observed:
“such as worked”: microstructure observed directly after the step of hot working;
“+1 h 300° C.”: microstructure observed after a heat treatment for 1 h at 300° C.
“+1 h 400° C.”: microstructure observed after a heat treatment for 1 h at 400° C.

A qualitative evaluation of the microstructure was carried out:
the term “substantially non-recrystallized” is used when the granular structure has little or no recrystallized grains, typically less than 20%, preferably less than 15% and more preferably less than 10% of the grains are recrystallized (FIG. 1 is a micrograph representative of this microstructure referred to as “substantially non-recrystallized”);
the term “recrystallized” is used when the granular structure has a substantial proportion of recrystallized grains, typically more than 50%, preferably more than 60% and more preferably more than 80% of the grains are recrystallized (FIG. 2 is a photograph representative of this microstructure referred to as “recrystallized”);
the term “partially recrystallized” is used when the granular structure is intermediary between the two preceding ones (FIG. 1 is a photograph representative of this microstructure referred to as “partially recrystallized”).

Table 3 shows the results of the microstructural observations of the samples having composition A, B or C, and FIG. 1 shows photographs representative of the various cases observed.

TABLE 3
Microstructure (plane LxTC, at mid-thickness) of the book mold ingots

| Alloy | | Microstructure |
|---|---|---|
| A | such as worked | substantially non- |
| | | recrystallized |
| | +1 h 300° C. | recrystallized |
| | +1 h 400° C. | recrystallized |
| B | such as worked | substantially non- |
| | | recrystallized |
| | +1 h 300° C. | partially recrystallized |
| | +1 h 400° C. | recrystallized |
| C | such as worked | substantially non- |
| | | recrystallized |
| | +1 h 300° C. | substantially non- |
| | | recrystallized |
| | +1 h 400° C. | recrystallized |

The alloy C according to the invention has an excellent resistance to recrystallization after heat treatment for one hour at approximately 300° C.

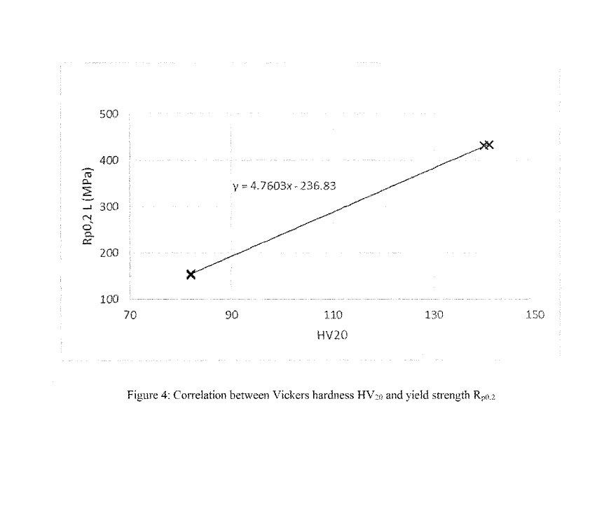

The inventors have moreover experimentally determined a correlation between the hardness measurements and the yield strength (R_{p0.2}) for this type of product based on additional tests comprising cold rolled samples after hot working. This made it possible to extend the hardness range and therefore the yield strength in order to provide a better representativeness of the correlation. FIG. 4 shows this correlation. A calculated R_{p0.2} based on this correlation is therefore also shown in table 2.

The inventors think that an industrial reduction in thickness by working by a factor from 50 to 100 would have given higher R_{p0.2} than in the case of the laboratory of this example for which the reduction was a factor of 4.

TABLE 3
Vickers Hardness (plane LxLT, t/10) of the samples, evaluated according
to the standard NF EN ISO 6507-1 (March 2006), and
calculated R_{p0.2} (MPa)

| | | | Calculated R_{p0.2} |
|---|---|---|---|
| Alloy | | Hardness (HV₂₀) | (MPa) |
| A | such as worked | 97 | 226 |
| | +1 h 300° C. | 89 | 186 |
| | +1 h 400° C. | 82 | 153 |
| B | such as worked | 101 | 246 |
| | +1 h 300° C. | 92 | 203 |
| | +1 h 400° C. | 84 | 162 |
| C | such as worked | 101 | 243 |
| | +1 h 300° C. | 98 | 229 |
| | +1 h 400° C. | 86 | 175 |

The alloys A and B have a drop in calculated Rp0.2 of 40 and 43 MPa respectively after a heat treatment for one hour at approximately 300° C., while the alloy C has a loss of 14 MPa.

1. Wrought aluminum alloy product having composition, in % by weight,
Mg: 4.0-5.5;
Li: 0.4-0.7;
Mn: 0.5-0.9;
Zr: 0.08-0.15;
Si: ≤0.2;
Fe: ≤0.25;
Zn: ≤0.4;
Sc: ≤0.4;
Ti: ≤0.15;
Er, Yb, Gd, Y, Hf and/or Nb: ≤0.2;
other elements ≤0.05 each and ≤0.15 in association; the remainder being aluminum.

2. Wrought product according to claim 1,
comprising, in % by weight, 4.4-5.3; optionally 4.8-5.2 of Mg.

3. Wrought product according to claim 1 comprising, in % by weight, 0.4-0.6 of Li.

4. Wrought product according to claim 1 comprising, in % by weight, 0.6-0.9 of Mn.

5. Wrought product according to claim 1 comprising, in % by weight, ≤0.05, optionally from 0.005 to 0.04, and optionally from 0.01 to 0.03 of Ti.

6. Wrought product according to claim 1 having a thickness of 0.5 and 30 mm, optionally from 2 to 8 mm.

7. Wrought product according to claim 1, having at mid-thickness, for a thickness of 0.5 and 30 mm, a substantially non-recrystallized microstructure.

8. Wrought product according to claim 1, having a hardness HV such that λ<0.4, optionally <0.3 and, optionally <0.25.

9. Method for manufacturing a wrought aluminum alloy product comprising:
a) casting of an unwrought product in aluminum alloy having composition, in % by weight,
Mg: 4.0-5.5;
Li: 0.4-0.7;
Mn: 0.5-0.9;
Zr: 0.08-0.15;
Si: ≤0.2;
Fe: ≤0.25;
Zn: ≤0.4;
Sc: ≤0.4;
Ti: ≤0.15;
Er, Yb, Gd, Y, Hf and/or Nb: ≤0.2;
other elements ≤0.05 each and ≤0.15 in association; the remainder being aluminum;
b) optionally, homogenizing;
c) hot working of the unwrought product at an end of working temperature greater than 250° C., optionally between 250 and 350° C.;
d) heat or thermomechanical treatment at a temperature between 250 and 350° C., optionally between 275 and 325° C.

10. Method according to claim 9 free of cold working inducing a total plastic cold-working greater than or equal to 2%.

11. Product comprising a wrought product according to claim 1, adapted for carrying out a structural element of an aircraft, optionally a fuselage skin.

12. Aluminum alloy structural element of aircraft having composition, in % by weight, Mg: 4.0-5.5; Li: 0.4-0.7; Mn: 0.5-0.9; Zr: 0.08-0.15; Si: ≤0.2; Fe: ≤0.25; Zn: ≤0.4; Sc: ≤0.4; Ti: ≤0.15; Er, Yb, Gd, Y, Hf and/or Nb: ≤0.2; other elements ≤0.05 each and ≤0.15 in association; the remainder being aluminum; having been subjected to a heat treatment or a thermomechanical treatment at a temperature between 250 and 350° C. and having, at mid-thickness, for a thickness of 0.5 and 20 mm, a substantially non-recrystallized microstructure.
